(19) United States
(12) Patent Application Publication
(10) Pub. No.: US 2013/0291818 A1
(43) Pub. Date: Nov. 7, 2013

(54) LASER SPARK PLUG FOR AN INTERNAL COMBUSTION ENGINE AND OPERATING METHOD FOR THE SAME

(71) Applicants: Rene Hartke, Stuttgart (DE); Heiko Ridderbusch, Schwieberdingen (DE)

(72) Inventors: Rene Hartke, Stuttgart (DE); Heiko Ridderbusch, Schwieberdingen (DE)

(21) Appl. No.: 13/881,656

(22) PCT Filed: Sep. 8, 2011
(86) PCT No.: PCT/EP2011/065570

§ 371 Date: Jul. 23, 2013

(30) Foreign Application Priority Data
Oct. 26, 2010 (DE) 10 2010 042 909.0

(51) Int. Cl. F02P 23/04

(52) U.S. Cl. CPC F02P 23/04
USPC 123/143 B; 701/102

(57) ABSTRACT

A laser spark plug for an internal combustion engine has a laser device including a plurality of surface emitting semiconductor lasers for generating laser pulses.

### BACKGROUND OF THE INVENTION

1. FIELD OF THE INVENTION

The present invention relates to a laser spark plug for an internal combustion engine having a laser device for generating laser pulses. The present invention also relates to a method for operating such a laser spark plug.

2. DESCRIPTION OF THE RELATED ART

It is already known that passively Q-switched laser devices are used for laser spark plugs of internal combustion engines. Passively Q-switched laser systems have the disadvantage that they require a relatively complex construction of the laser spark plug and cause high manufacturing costs.

### BRIEF SUMMARY OF THE INVENTION

Accordingly, the object of the present invention is to improve upon a laser spark plug and a method for operating a laser spark plug of the type defined at the outset, so that a design of a lower complexity and also lower production costs are achieved.

This object is achieved according to the present invention in the laser spark plug of the type defined at the outset by the fact that the laser device has a plurality of surface emitting semiconductor lasers for generating the laser pulses. Surface emitting semiconductor lasers, also referred to in English as vertical cavity surface emitting lasers (VCSEL), have the significant advantage over traditional Q-switched laser systems having a laser-active solid in that they permit extremely small dimensions and have a low sensitivity to temperature. The plurality of VCSEL semiconductor lasers provided according to the present invention is also referred to hereinafter as VCSEL array.

In addition to a simplified design of the laser spark plug, the use of surface emitting semiconductor lasers according to the present invention also permits significant cost reductions since, as expected, the manufacturing costs of semiconductor lasers such as surface emitting semiconductor lasers decline more with the number of units than do the costs for solid-state lasers and other optical elements, which are required for the operation of solid-state lasers.

In a preferred specific embodiment, it is provided that the laser device is integrated into the laser spark plug, and that the laser device is hermetically encapsulated, so that it is advantageously not necessary to hermetically seal an entire interior space of a housing of the laser spark plug. Instead, by hermetically encapsulating the laser device itself, a less complex and thus less expensive sealing of the laser spark plug housing may be carried out. At the same time, hermetically sealing the laser device ensures that the semiconductor lasers are nevertheless protected from particles which might penetrate into the laser spark plug housing.

In another advantageous specific embodiment, it is provided that the laser device is designed to generate laser pulses of a wavelength of approximately 400 nanometers up to approximately 2500 nanometers, so that it is advantageously possible to adjust the wavelength of the semiconductor laser to absorption lines in a fuel/air mixture to be ignited. For example, a mixture containing methane may be ignited efficiently with the aid of wavelengths of approximately 1.33 μm (micrometers) and/or approximately 1.65 μm. The demand for optical pulse energy for the laser ignition pulses therefore drops advantageously because the absorption and thus the efficiency of the energy input of the laser ignition pulses into the mixture both increase. In the surface emitting semiconductor lasers proposed according to the present invention, the wavelength of the laser pulses to be emitted may be adjusted within a wide range—in contrast with traditional passively Q-switched solid-state lasers—so that efficient adaptation of the laser pulses generated according to the present invention to the mixture to be combusted is possible.

In another advantageous specific embodiment, it is provided that the laser device has means for phase coupling of individual semiconductor lasers, so that a high coherence of the laser pulses generated by the laser spark plug according to the present invention is achievable. The means for phase coupling may have, for example, a reference semiconductor laser, which is designed and/or situated in such a way that the radiation it generates acts upon additional semiconductor lasers of the laser device according to the present invention, so that these lasers are synchronized to the phase of the reference laser in a way known per se. Such a reference semiconductor laser is also referred to as a seed laser. The seed laser is preferably situated in such a way that the laser radiation it generates may be irradiated onto all surface emitting surface conductor lasers of the laser device to ensure maximum synchronicity of the involved surface emitting semiconductor lasers. The radiation of the seed laser ensures phase coupling of the individual emitters of the VCSEL array in a way known per se.

In another advantageous specific embodiment, it is provided that a plurality of surface emitting semiconductor lasers of the laser device is situated in an essentially planar configuration. Therefore, particularly efficient input of the laser radiation generated by the surface emitting semiconductor lasers into the combustion chamber of the internal combustion engine is possible, for example, using a focusing lens situated in the radiation path, for example, a focusing lens which may also function as a combustion chamber window at the same time.

In another very advantageous specific embodiment, multiple groups (“arrays”) of surface emitting semiconductor lasers are provided, and means are provided for superposing the laser radiation generated by the individual groups, so that a further increase in the power of the laser ignition pulses is possible. For example, the radiation of multiple VCSEL arrays, i.e., the multiple groups of surface emitting semiconductor lasers, may be superposed by known restacking techniques using stepped mirrors, for example, so that a higher power density is obtained. In particular, individual surface emitting semiconductor lasers having a different wavelength and/or polarization, for example, may be provided, their radiation being superposed by dichroic or polarization-dependent optical elements or a combination of same. Much higher radiation densities may be achieved in this way. In this specific embodiment, it is important to be sure that a focusing lens which bundles the laser pulses into the combustion chamber is designed to be appropriately broadband or is designed for the used polarizations.

In another advantageous specific embodiment, an optical amplifier is provided for optical amplification of the laser pulses generated by the laser device, and a pump light source is provided for optical pumping of the optical amplifier. Using the pump light source, the optical amplifier may be optically pumped in a way known per se to build up a population inversion, which is removed during emission of the laser pulse with the aid of the laser device according to the present invention to optically amplify the laser pulse in a way known per se.

In another preferred specific embodiment, the pump light source has at least one semiconductor laser, in particular a plurality of surface emitting semiconductor lasers. This means that in this specific embodiment, the laser pulse which is used for laser ignition and is to be optically amplified and also the laser radiation used for optical pumping of the optical amplifier are each supplied by a group of surface emitting semiconductor lasers or multiple VCSEL arrays. According to another advantageous specific embodiment, the various VCSEL arrays may preferably also be situated on a shared heat sink.

In yet another advantageous specific embodiment, it is provided that the pump light source is integrated into the laser spark plug and that an input lens is provided for longitudinally inputting the laser pulses of the laser device and pump radiation generated by the pump light source into the optical amplifier, so that a particularly good spatial overlap is achieved between the pump volume in the optical amplifier and the laser pulse to be amplified, which results in an efficient optical amplification.

Alternatively or additionally, transverse input of pump radiation into the optical amplifier is also possible, and surface emitting semiconductor lasers may again be used advantageously to form the pump light source for the transverse pumping. A combination of longitudinal and transverse pumping is also possible.

The principle according to the present invention is not limited to the use of surface emitting semiconductor lasers for generating the pump light for the optical amplifier but instead other semiconductor lasers (for example, edge emitters) may also be used to supply the pump light for the optical amplifier.

Another method is provided as an additional approach to achieving the object of the present invention. According to this method, the laser device has a plurality of surface emitting semiconductor lasers for generating the laser pulses, and the laser device is triggered in such a way that it generates at least one laser pulse having a pulse period of 100 ns (nanoseconds) or less, preferably 20 ns or less within one working cycle of a cylinder of the internal combustion engine.

In another preferred specific embodiment, it is provided that the laser device is operated at a pulse-pause ratio of less than approximately 1:100, preferably less than approximately 1:1000, whereby significantly higher pulse powers of the surface emitting semiconductor lasers may be achieved according to research by the present patent applicant. The surface emitting semiconductor lasers in particular experience very little heating during operating periods of less than one microsecond and with pulse-pause ratios of less than one per mill and may therefore be operated at much higher current levels than is the case at the higher pulse-pause ratios. The pulse periods may preferably be less than 10 ns.

In another preferred specific embodiment, it is provided that multiple laser pulses, in particular preferably between approximately 10 pulses and approximately 1000 pulses, each having a maximum pulse period of approximately 20 ns and a minimum pulse energy of approximately 0.1 mJ (millijoule), are generated within one working cycle, so that particularly reliable ignition of the fuel/air mixture is ensured. Pulse energies of approximately 0.1 mJ to approximately 10 mJ are preferred in particular.

The plurality of surface emitting semiconductor lasers of the laser device is preferably operated in particular with phase coupling to generate the laser pulses, which thus ensures the greatest possible coherence of the laser pulses thereby generated and thus ensures reliable ignition of the fuel/air mixture to be ignited.

Additional features, possible applications and advantages of the present invention are derived from the following description of exemplary embodiments of the present invention, which are illustrated in the figures of the drawing. All features described or illustrated here, either alone or in any combination, constitute the subject matter of the present invention, regardless of their summary in the patent claims or their back-references and also independently of how they are worded in the description and illustrated in the drawing.

### BRIEF DESCRIPTION OF THE DRAWINGS

FIG. 1 shows an internal combustion engine having a laser spark plug according to the present invention.

FIG. 2 schematically shows a first specific embodiment of the laser spark plug according to the present invention from FIG. 1 in detail.

FIG. 3 shows another specific embodiment of the laser spark plug according to the present invention.

### DETAILED DESCRIPTION OF THE INVENTION

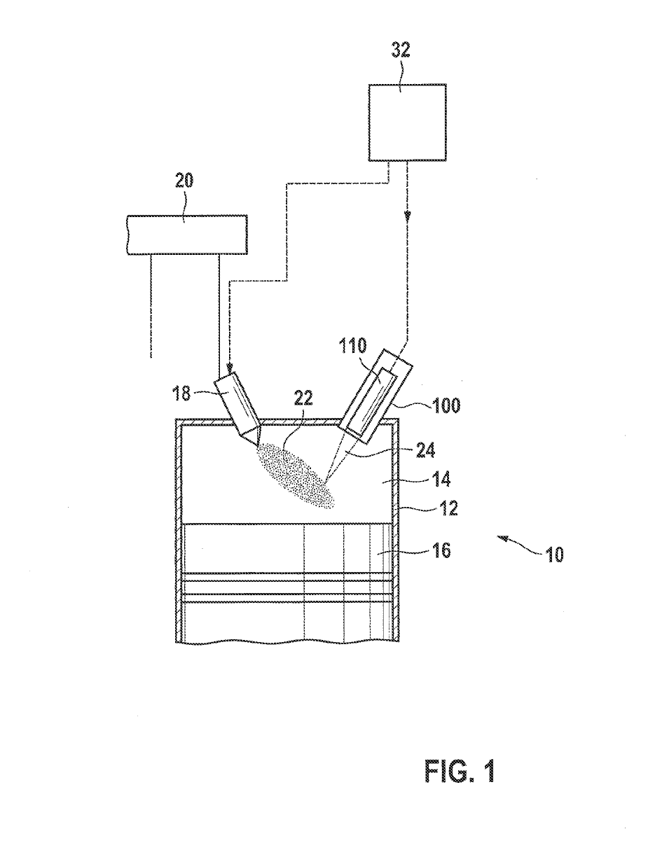

An internal combustion engine is labeled with reference numeral 10 on the whole in FIG. 1. It is used to drive a motor vehicle (not shown). Internal combustion engine 10 includes multiple cylinders, only one of which is labeled with reference numeral 12 in FIG. 1. A combustion chamber 14 of cylinder 12 is delimited by a piston 16. Fuel reaches combustion chamber 14 directly through an injector 18, which is connected to a fuel pressure accumulator 20, also known as a rail.

Fuel 22 injected into combustion chamber 14 is ignited with the aid of a laser beam 24, which is preferably emitted into combustion chamber 14 in the form of a laser pulse 24 by a laser spark plug 100 having a laser device 110. Laser device 110 is therefore controlled by a control unit 32, which also triggers injector 18.

According to the present invention, laser device 110 of laser spark plug 100 has a plurality of surface emitting semiconductor lasers to generate laser pulses 24.

The plurality of surface emitting semiconductor lasers, also referred to as VCSEL arrays, has important advantages in comparison with traditional passively Q-switched solid-state laser systems. On the one hand, such VCSEL arrays have very small dimensions, so that the construction of laser spark plug 100 is greatly simplified. In addition, VCSEL arrays have relatively low production costs.

In addition to the VCSEL array of laser device 110, laser spark plug 100 has a focusing lens 26 in a way known per se via which laser radiation 24 generated by the VCSEL array of laser device 110 is focused on an ignition point in combustion chamber 14, which is not identified further.

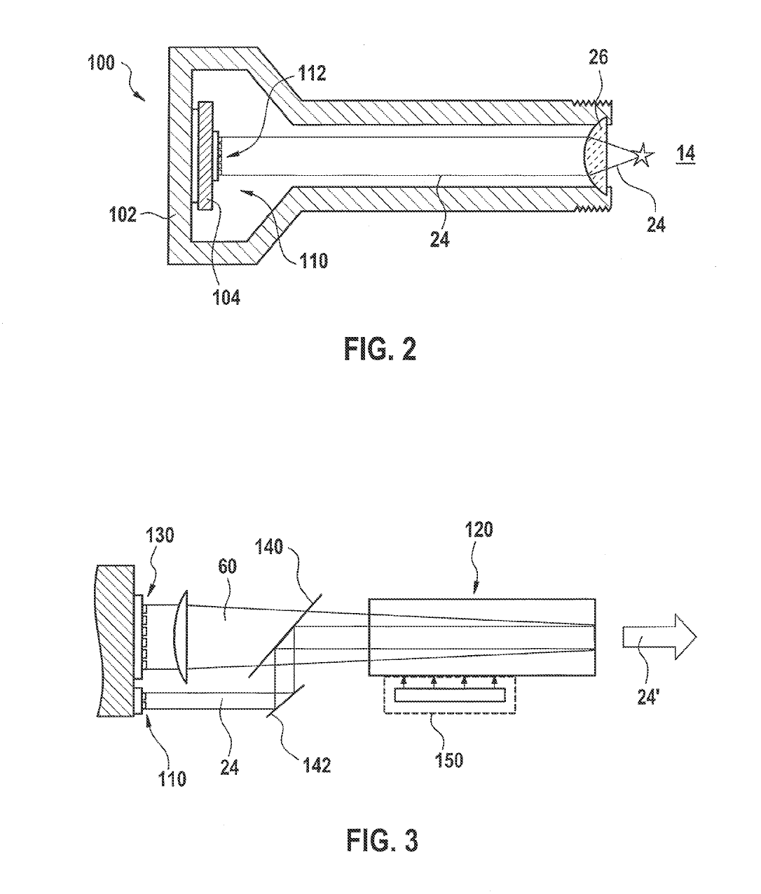

In a preferred specific embodiment, laser device 110 is integrated directly into housing 102 of laser spark plug 100, as illustrated in FIG. 2. Laser device 110 is additionally hermetically encapsulated, which is particularly advantageous, so that the seal on remaining laser spark plug housing 102 may be designed to be simpler, in particular in the area of focusing lens 26, which is a combustion chamber window at the same time, than is the case with such systems in which laser device 110 is not hermetically encapsulated separately.

The VCSEL array of laser device 110 is preferably designed in particular to generate laser pulses 24 of a wavelength corresponding approximately to the absorption wavelengths of components of fuel/air mixture 22 to be ignited (FIG. 1), thus yielding more efficient laser ignition, even at lower pulse energies.

For example, a mixture containing methane may be ignited efficiently with the aid of wavelengths of approximately 1.33 μm (micrometer) and/or approximately 1.65 μm.

Laser device 110 may preferably also include in particular means 112 for phase coupling of individual semiconductor lasers of the VCSEL array. For example, one surface emitting semiconductor laser of laser device 110 is designed in such a way that it is triggered a short time before the other surface emitting semiconductor lasers of laser device 110, and the laser radiation it generates is irradiated onto all the other surface emitting semiconductor lasers of laser device 110. In this way, the other surface emitting semiconductor lasers may be synchronized with the reference laser, which is also referred to as a seed laser, thus ensuring a maximum coherence of laser radiation 24 emitted by laser device 110.

One variant of the present invention which is structurally particularly less complex provides for the plurality of surface emitting semiconductor lasers of laser device 110 to be situated in an essentially planar configuration. For example, the individual surface emitters may be situated in such a way that they emit the laser radiation thereby generated directly in the direction of combustion chamber window 26 when situated on heat sink 104 as illustrated in FIG. 2.

In another advantageous specific embodiment, it is possible for multiple groups of surface emitting semiconductor lasers to be provided and for means for superposing the laser radiation generated by the individual groups (VCSEL arrays) to be provided. For example, VCSEL arrays (not shown) emitting in different spatial directions may be provided, their laser radiation in turn being superposed via suitable mirror devices, for example, stepped mirrors to form laser pulse 24. Lasers with different wavelengths and/or polarizations may also be integrated into laser device 110 through such a configuration, which is also known as a restacking technique, thereby permitting a further increase in the power density or in the pulse energy.

FIG. 3 shows another specific embodiment having a laser device 110 according to the present invention, additionally having an optical amplifier 120. Optical amplifier 120 is acted upon with pump light 60 by a pump light source 130. Pump light source 130 may also advantageously be a VCSEL array.

The configuration illustrated in FIG. 3 advantageously yields longitudinal optical pumping of optical amplifier 120, so that an optimal overlap between pump radiation 60 and laser radiation 24 to be amplified is achieved in optical amplifier 120. On its end face at the right in FIG. 3, optical amplifier 120 may preferably be coated to be highly reflective for pump radiation 60, so that pump radiation 60 passes through optical amplifier 120 at least twice in the longitudinal direction to permit even more efficient optical pumping.

FIG. 3 also indicates an additional optional pump light source 150, which is designed to act upon optical amplifier 120 transversely with pump light. A combination of longitudinal and transverse optical pumping is also possible.

Strictly transverse pumping is also conceivable. Transverse pumping in principle allows the use of longer amplifier crystals 120 and therefore higher amplification factors.

An amplified laser pulse 24′ is obtained at the output of optical amplifier 120.

Input of laser radiation 24 generated by laser device 110 into optical amplifier 120 is accomplished in the present case with the aid of a mirror optics system 140, 142, a first mirror 142 deflecting laser radiation 24 onto a dichroic second mirror 140, which ultimately deflects laser radiation 24 in the longitudinal direction into optical amplifier 120. Dichroic mirror 140 is preferably highly transmissive for the wavelength of pump radiation 60.

The principle according to the present invention using VCSEL arrays, i.e., a plurality of surface emitting semiconductor lasers, for generating laser pulses 24 advantageously makes it possible to generate at least one laser pulse 24 having a pulse period of 100 ns or less, preferably 20 ns or less, during a single operating cycle of a cylinder 12 of internal combustion engine 10 (FIG. 1). Laser device 110 is in particular preferably operated with a pulse-pause ratio of less than approximately 1:100, preferably less than approximately 1:1000, so that, according to research by the present applicant, a high optical output power per laser device 110 may be achieved with low heating of laser device 110 at the same time. In particular, laser device 110 may be operated at much higher current levels in comparison with traditional triggering methods, whereby the pulse periods may even be shorter than 10 ns.

In another specific embodiment, which is particularly preferred, it is provided that multiple laser pulses 24, each having a maximum pulse period of approximately 20 ns and a minimum pulse energy of approximately 0.1 mJ, are generated within one operating cycle, so that particularly reliable ignition of the fuel/air mixture in combustion chamber 14 is ensured (FIG. 1).

If laser device 110 of laser spark plug 100 is operated through corresponding electrical triggering (cf. control unit 32 in FIG. 1) with a relatively low pulse-pause ratio of less than or equal to approximately 1:1000, then a particularly large number of laser pulses 24 having a pulse period in the range of a few 10 ns may be emitted one after the other with a similar pulse energy. Since the fuel/air mixture in combustion chamber 14 does not move much farther during a microsecond, an increased amount of ignition energy in comparison with traditional laser ignition methods may be introduced into the plasma while utilizing the operating method according to the present invention, and thus the probability of reliable ignition may be increased or the ignition energy demand per individual laser pulse 24 may be reduced.

Another particular advantage of the configuration according to the present invention is the possibility of accurately adjusting the ignition time with a precision of a few nanoseconds because VCSEL array 110 converts an electrical trigger signal into a laser pulse 24 with almost no delay.

In the specific embodiment according to FIG. 3, optical amplifier 120 may have a Yb (ytterbium)-doped host material, for example, for which pump light wavelengths of 940 mm and/or approximately 975 nm to 980 nm and pump periods of approximately <1 ms (millisecond) are appropriate. After such a pumping operation, laser pulse 24, also referred to as a seed pulse, of laser device 110 is input into optical amplifier 120 through input lens 140, 142. Laser pulse 24, which functions as a seed pulse, should have a wavelength near an amplification maximum of optical amplifier material 120. For example, a wavelength of 1030 nm is appropriate for Yb-doped materials. Seed pulse 24 should already have a minimum energy of a few 100 μJ (microjoule) to be amplified well. To enable a preferably efficient optical amplification, pump radiation 60 and seed radiation 24 should be guided through optical amplifier 120 preferably in parallel and with the same beam diameter. In this case, a maximally efficient reduction of the population inversion generated by pump laser 130 in optical amplifier 120 is made possible by seed pulse 24.

As already described above with reference to FIG. 2, the seed laser, i.e., laser device 110, may advantageously be implemented in a phase-coupled manner to obtain laser radiation 24 in a preferably coherent form. Higher intensities may therefore be achieved at the ignition point in combustion chamber 14.

For example, Yb:YAG (ytterbium-doped ytterbium-aluminum-garnet) is advantageous as the material for optical amplifier 120 due to its long fluorescence lifetime and the absorption wavelengths, which are suitable for semiconductor laser 110 in particular. However, other Yb-doped materials (in particular garnets and sesquioxides) are also suitable.

1-15. (canceled)

16. A laser spark plug for an internal combustion engine, comprising:
a laser device for generating laser pulses, wherein the laser device has a plurality of surface emitting semiconductor lasers for generating the laser pulses.

17. The laser spark plug as recited in claim 16, wherein the laser device is integrated into the laser spark plug, and wherein the laser device is hermetically encapsulated.

18. The laser spark plug as recited in claim 17, wherein the laser device is configured to generate laser pulses having a wavelength of approximately 400 nanometers up to approximately 2500 nanometers.

19. The laser spark plug as recited in claim 18, wherein the laser device has an element for phase coupling of individual semiconductor lasers.

20. The laser spark plug as recited in claim 18, wherein multiple surface emitting semiconductor lasers of the laser device are situated in an essentially planar configuration.

21. The laser spark plug as recited in claim 18, wherein multiple groups of surface emitting semiconductor lasers are provided, and an element for superposing the laser radiation generated by the individual group is provided.

22. The laser spark plug as recited in claim 21, wherein the element for superposing the laser radiation has at least one of a dichroic element and a polarization-dependent element.

23. The laser spark plug as recited in claim 18, further comprising:
an optical amplifier for optical amplification of the laser pulses generated by the laser device; and
a pump light source for optical pumping of the optical amplifier.

24. The laser spark plug as recited in claim 23, wherein the pump light source has a plurality of surface emitting semiconductor lasers.

25. The laser spark plug as recited in claim 23, wherein the pump light source is integrated into the laser spark plug, and an input lens is provided for longitudinally inputting the laser pulses of the laser device and pump radiation generated by the pump light source into the optical amplifier.

26. The laser spark plug as recited in claim 23, wherein the laser device and the pump light source are situated on a shared heat sink.

27. A method for operating laser spark plug for an internal combustion engine, wherein the laser spark plug has a laser device including a plurality of surface emitting semiconductors lasers for generating laser pulses, the method comprising:
controlling the laser device to generate at least one laser pulse having a pulse period of no greater than 20 nanoseconds, within one operating cycle of a cylinder of the internal combustion engine.

28. The method as recited in claim 27, wherein the laser device is operated at a pulse-pause ratio of less than approximately 1 to 1000.

29. The method as recited in claim 28, wherein multiple laser pulses, each having a maximum pulse period of approximately 20 nanoseconds and a minimum pulse energy of approximately 0.1 millijoule, are generated within one operating cycle.

30. The method as recited in claim 28, wherein the surface emitting semiconductor lasers of the laser device are operated in a phase-coupled manner.
